(19) United States
(12) Patent Application Publication
(10) Pub. No.: US 2026/0051066 A1
(43) Pub. Date: Feb. 19, 2026

(54) TRACKING OBJECTS

(71) Applicant: QUALCOMM Incorporated, San Diego, CA (US)

(72) Inventors: Diptiben Navinchandra PATEL, San Diego, CA (US); Amin ANSARI, Kirkland, WA (US); Madhumitha SAKTHI, Dublin, CA (US); Thomas SVANTESSON, Linköping (SE)

(21) Appl. No.: 18/807,806

(22) Filed: Aug. 16, 2024

(51) Int. Cl. G06T 7/20; G06T 5/20; G06V 10/25; G06V 10/44; G06V 10/74; G06V 10/80

(52) U.S. Cl. CPC G06T 7/20; G06T 5/20; G06V 10/25; G06V 10/44; G06V 10/761; G06V 10/806; G06T 2207/20084; G06V 2201/07

(57) ABSTRACT

Systems and techniques are described herein for tracking objects. For instance, a method for tracking objects is provided. The method may include generating features based on a sensor-data frame; detecting an object based on the features; generating a bounding box based on the object; tracking the bounding box over a plurality of sensor-data frames to generate a tracklet, wherein the tracklet comprises a respective bounding box for each sensor-data frame of the plurality of sensor-data frames and an identifier; and combining the bounding box and a bounding box of the tracklet to generate an output bounding box.

### TECHNICAL FIELD

The present disclosure generally relates to object tracking. For example, aspects of the present disclosure include systems and techniques for tracking objects in images.

### BACKGROUND

Object tracking may be an important computer-vision task for various applications, including, as examples, autonomous vehicles, semi-autonomous vehicles, robots, security systems, traffic surveillance, crowd monitoring, augmented reality, and sports analysis. Object tracking may involve determining a position of an object and tracking the position of the object over time. To track an object, a system may capture successive image frames (e.g., of video data) of a scene including the object. The system may detect the object in each of the image frames. The system may further determine a position of the object (e.g., relative to the system or relative to a reference coordinate system) based on each of the successive image frames and track the position of the object over time.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for tracking objects. According to at least one example, a method is provided for tracking objects. The method includes: generating features based on a sensor-data frame; detecting an object based on the features; generating a bounding box based on the object; tracking the bounding box over a plurality of sensor-data frames to generate a tracklet, wherein the tracklet comprises a respective bounding box for each sensor-data frame of the plurality of sensor-data frames and an identifier; and combining the bounding box and a bounding box of the tracklet to generate an output bounding box.

In another example, an apparatus for tracking objects is provided that includes at least one memory and at least one processor (e.g., configured in circuitry) coupled to the at least one memory. The at least one processor configured to: generate features based on a sensor-data frame; detect an object based on the features; generate a bounding box based on the object; track the bounding box over a plurality of sensor-data frames to generate a tracklet, wherein the tracklet comprises a respective bounding box for each sensor-data frame of the plurality of sensor-data frames and an identifier; and combine the bounding box and a bounding box of the tracklet to generate an output bounding box.

In another example, a non-transitory computer-readable medium is provided that has stored thereon instructions that, when executed by one or more processors, cause the one or more processors to: generate features based on a sensor-data frame; detect an object based on the features; generate a bounding box based on the object; track the bounding box over a plurality of sensor-data frames to generate a tracklet, wherein the tracklet comprises a respective bounding box for each sensor-data frame of the plurality of sensor-data frames and an identifier; and combine the bounding box and a bounding box of the tracklet to generate an output bounding box.

In another example, an apparatus for tracking objects is provided. The apparatus includes: means for generating features based on a sensor-data frame; means for detecting an object based on the features; means for generating a bounding box based on the object; means for tracking the bounding box over a plurality of sensor-data frames to generate a tracklet, wherein the tracklet comprises a respective bounding box for each sensor-data frame of the plurality of sensor-data frames and an identifier; and means combining the bounding box and a bounding box of the tracklet to generate an output bounding box.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 includes four example images to illustrate various principles of object tracking;

FIG. 2 includes four example images to illustrate various principles of object tracking;

FIG. 3 includes four example images to illustrate various principles of object tracking;

FIG. 4 is a block diagram illustrating a system for tracking objects, according to various aspects of the present disclosure;

FIG. 5 is a block diagram illustrating an example implementation of the tracker model of FIG. 4, according to various aspects of the present disclosure;

FIG. 6 is a block diagram illustrating a process for tracking objects, according to various aspects of the present disclosure;

FIG. 7 includes an example image of four people overlaid with proposal and track query predictions, according to various aspects of the present disclosure;

FIG. 8 includes an example query attention map, according to various aspects of the present disclosure;

FIG. 9 is a flow diagram illustrating an example process for tracking objects, in accordance with aspects of the present disclosure;

FIG. 10 is a block diagram of an example transformer in accordance with some aspects of the disclosure; and

FIG. 11 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Object tracking (including multi-object tracking (MOT)) is a useful computer-vision task. Object tracking may involve estimating respective bounding boxes for objects in images. A bounding box may describe a position of an object in an image. For example, a bounding box May describe pixel positions describing pixels representing an object. For instance, a bounding box may define corners of a rectangle that includes pixels that represent an object.

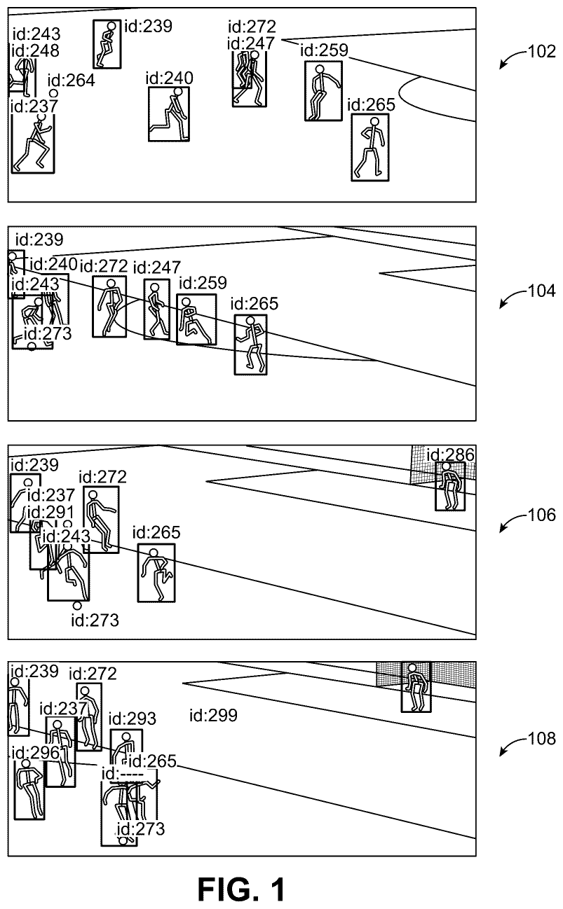

Object tracking may also involve associating bounding boxes across multiple image frames (e.g., of video data). For example, object tracking may involve associating a first bounding box associated with a given object in a first image with a second bounding box associated with the given object in a second image. The object (and/or the first and second bounding boxes) may be associated with an identifier (ID) that may associate the first and second bounding boxes. Furthermore, the bounding box may also represent a box in a local coordinate system relative to the observer (Ego) conducting the object tracking, with absolute properties like longitudinal position, lateral displacement, relative height, roll, pitch, and/or yaw, and/or length, width and/or height of the bounding box represented. For example, FIG. 1-FIG. 3 depicts such example bounding boxes projected back into examples image.

Object tracking (including MOT) may be used in various systems and/or applications, such as security (e.g., to enhance surveillance by, for example, detecting anomalies), robotics and/or driving (e.g., enabling tracking of objects in an environment to allow a robot or vehicle to navigate in the environment relative to the objects), sports analysis (e.g., allowing for performance analysis and/or player-movement understanding), traffic surveillance (e.g., monitoring vehicles and/or pedestrians for accident prevention and/or traffic-flow improvement), crowd monitoring, augmented reality (e.g., to anchor virtual objects to points in a scene), among others.

Existing MOT techniques face various challenges. For example, existing MOT techniques have difficulty balancing between simple linear motion (e.g., of cars moving on a highway) and complex dynamic motion (e.g., of cars and/or pedestrians moving in urban scenario). Existing MOT techniques use either a filtering-based approach (e.g., using a Kalman Filter, an extended Kalman filter (EKF), or unscented Kalman filter (UKF)) or a transformer-based tracking approach. Filtering-based approaches may work best for smooth linear motion scenarios but may fail to perform well in complex non-linear motion scenarios. Additionally, filtering-based approaches may struggle in maintaining the tracking ID for smaller objects in the scene due to poor appearance matching. Transformer-based tracking approaches learn complex dynamic motion and achieve long-range information dependency but require more computational resources than filtering-based approaches.

Systems, apparatuses, methods (also referred to as processes), and computer-readable media (collectively referred to herein as “systems and techniques”) are described herein for tracking objects. For example, the systems and techniques described herein may involve a gradient-boosting ensemble approach which utilizes a two-stage training paradigm for the multiple object tracking.

The systems and techniques may include a two-stage object tracker. The first stage may include an object detector trained using camera images (and, in some aspects, radio detection and ranging (RADAR) frames and/or light detection and ranging (LIDAR) frames) as inputs. The object detector may generate bounding boxes that are either associated to previous tracks or initiated as new tracks using a Kalman filter (or any other filtering-based approach, such as, a particle filter, an EKF, and/or a UKF) to generate object bounding boxes and tracklet IDs as an output. The second stage may include a tracking neural network (e.g., a transformer) that may use the bounding boxes output from the first stage as proposal queries and the tracklet IDs output from the first stage along with tracklet IDs of the previous frame as track queries.

According to the gradient-boosting approach, during training of the second stage, the weights of the first stage may be frozen. Training data samples for which the first stage generates an incorrect prediction will be given higher weights during the training of the second stage; thereby enabling the second stage to learn those cases that were harder for the first stage to predict. Further, overlapping bounding boxes may be combined using non-maximum suppression (NMS) to generate the refined bounding boxes and tracklet IDS. NMS may reduce a number of candidate (e.g., redundant) bounding regions. NMS can be used to reduce the number of candidate bounding regions (e.g., bounding boxes) so that candidate bounding regions with a high probability of containing an object are processed or output as an object detection output.

NMS may select a single bounding box from the overlapping bounding boxes. For example, The NMS operation can operate using a set of bounding box proposals (denoted as BB_{P}), a confidence score for each bounding box (denoted as S_{BB}), and overlap threshold (denoted as O_{Th}) as input, and can output a final set of bounding boxes (BB_{F}). For example, using the NMS operation, the bounding box encoding engine can select the proposal with the highest confidence score (denoted as BB₁), remove it from the proposals BB_{P}, and add it to the final set of bounding boxes BB_{F}. The bounding box encoding engine can then compare the proposal bounding box BB₁ with all of the bounding box proposals, such as by calculating the intersection-over-union (IoU) of the proposal BB₁ with every other proposal. If the IoU is greater than the threshold O_{Th}, the proposal BB₁ can be removed from the set of proposals BB_{P}. The bounding box encoding engine can then take the proposal in the updated set of proposals BB_{P} with the highest confidence (denoted to as BB₂) and remove the proposal BB₂ from BB_{P} and add the proposal BB₂ to BB_{F}. The bounding box encoding engine can calculate the IoU of the proposal BB₂ with all the proposals in BB_{P} and eliminate the boxes which have an IoU greater than the threshold O_{Th}. This NMS operation can be repeated until there are no longer any proposals left in BB_{P}. Alternatively, bounding boxes may be combined according to an intersection-over-union approach or a total-area approach.

Because the second stage may be trained to handle the complex motion scenarios (e.g., cases in which the first stage produced incorrect results), in case of linear object motion (e.g., in simple highway scenarios), the output of the first stage may be directly utilized for further processing and the second stage (including the compute-heavy transformer layers) may be bypassed or disabled. The systems and techniques may determine whether to bypass or disable the second stage by comparing tracking metrics, such as multi-object tracking accuracy (MOTA) and/or higher-order tracking accuracy (HOTA) of the first and second stage outputs.

Many existing approaches employ filtering-based methods. The performance of filtering-based methods is limited by the hand-designed motion and observation models. The motion model is likely to fall short in case in which tracked objects perform complex maneuvers, such as a U-turn or a sudden drift.

The systems and techniques include a transformer-based technique and a filtering-based technique. The systems and techniques output refinements to bounding box locations and track IDs, due to the transformer's ability to learn complex motion patterns and distinguishable appearance features.

The systems and techniques may be trained according to a gradient-boosting technique such that linear motion scenarios (e.g., simple highway scenarios) are handled by the first stage (e.g., the filtering-based technique) and complex motion scenarios (e.g., a dense urban environment) is handled by the second stage (e.g., the transformer-based technique).

In some cases, a toggle can be used to disable or bypass the compute-heavy second stage to conserve computational resources. Disabling or bypassing the second stage may allow for faster processing (e.g., processing more frames per second (fps)) in highway scenarios. Toggling can be triggered if the covariance, prediction error, or innovation error is found to be large (e.g., exceeding a threshold).

Although MOT approaches solely based on detection followed by tracking are prone to ID switches, the systems and techniques will result in fewer ID switches due to the second stage (the transformer-based tracking) which learns the appearance embeddings of the objects.

Various aspects of the application will be described with respect to the figures below.

FIG. 1 includes four example images (image 102, image 104, image 106, and image 108) to illustrate various principles of object tracking. Image 102, image 104, image 106, and image 108 may be four images of a series of images (e.g., of video data) captured by a camera. An object detector may detect objects (e.g., players and a ball) in each of image 102, image 104, image 106, and image 108. Further, the object detector may generate bounding boxes indicative of pixels representing each of the detected objects. For example, the object detector may detect a first player (e.g., labeled with identifier “id: 243”) in each of image 102, image 104, image 106, and image 108 and generate a bounding box in each of image 102, image 104, image 106, and image 108 indicative pixels representing the first player.

An object tracker may associate the objects detected in each of the images with identifiers. Associating objects with identifiers may allow the objects to be tracked across the images. For example, the first player (detected in each of image 102, image 104, image 106, and image 108) may be associated with the identifier “id: 243” and a second player (also detected in each of image 102, image 104, image 106, and image 108) may be associated with the identifier “id: 265.” The position of the first player and the position of the second player may be tracked over time and may be analyzed.

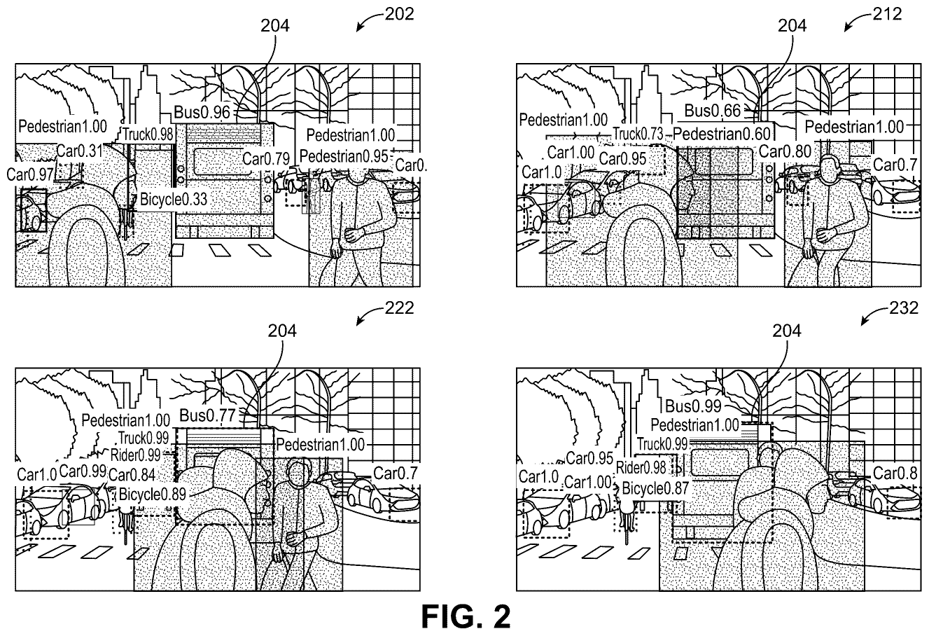

FIG. 2 includes four example images (image 202, image 212, image 222, and image 232) to illustrate various principles of object tracking. Image 202, image 212, image 222, and image 232 may be four images of a series of images (e.g., of video data) captured by a camera. An object detector may detect objects (e.g., vehicles and pedestrians) in each of image 202 image 212, image 222, and image 232. Further, the object detector may generate bounding boxes indicative of pixels representing each of the detected objects. An object tracker may associate the objects detected in each of the images with identifiers to allow the objects to be tracked across the images. For example, the object tracker may associate bus 204 in image 202 with identifier “bus0.96.”

Sole-appearance-based techniques may fail in cases in which objects are occluded in images due to appearance embedding similarity of the foreground and background object. For example, based on pedestrians walking between the camera that captured image 202, image 212, image 222, and image 232 and bus 204 (e.g., occlusions), the object detector may associate bus 204 in image 202 with identifier “bus0.96,” bus 204 in image 212 with identifier “bus0.66,” bus 204 in image 222 with identifier “bus0.77,” and bus 204 in image 232 with identifier “bus0.99.” Such associations may not allow bus 204 to be tracked across image 202, image 212, image 222, and image 232.

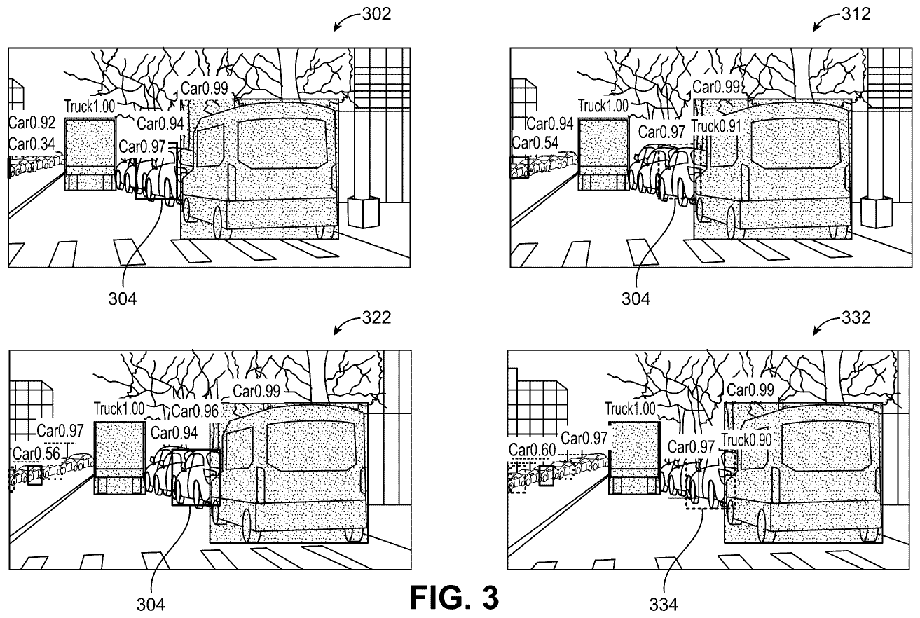

FIG. 3 includes four example images (image 302, image 312, image 322, and image 332) to illustrate various principles of object tracking. Image 302, image 312, image 322, and image 332 may be four images of a series of images (e.g., of video data) captured by a camera. An object detector may detect objects (e.g., vehicles) in each of image 302, image 312, image 322, and image 332. Further, the object detector may generate bounding boxes indicative of pixels representing each of the detected objects. An object tracker may associate the objects detected in each of the images with identifiers to allow the objects to be tracked across the images. For example, the object detector may associate truck 304 in image 302 with identifier “car0.94.”

Existing tracking techniques may rely on the detection capability of the object detector. In cases in which there is a class switch in the detection output, the class switch may directly impact the tracking performance. For example, due to a class-prediction switch, the object tracker may associate truck 304 in image 302 with identifier “car0.94,” truck 304 in image 312 with identifier “truck0.91,” truck 304 in image 322 with identifier “car0.86,” and truck 304 in image 332 with identifier “truck0.90.” Such associations may not allow truck 304 to be tracked across image 302, image 312, image 322, and image 332.

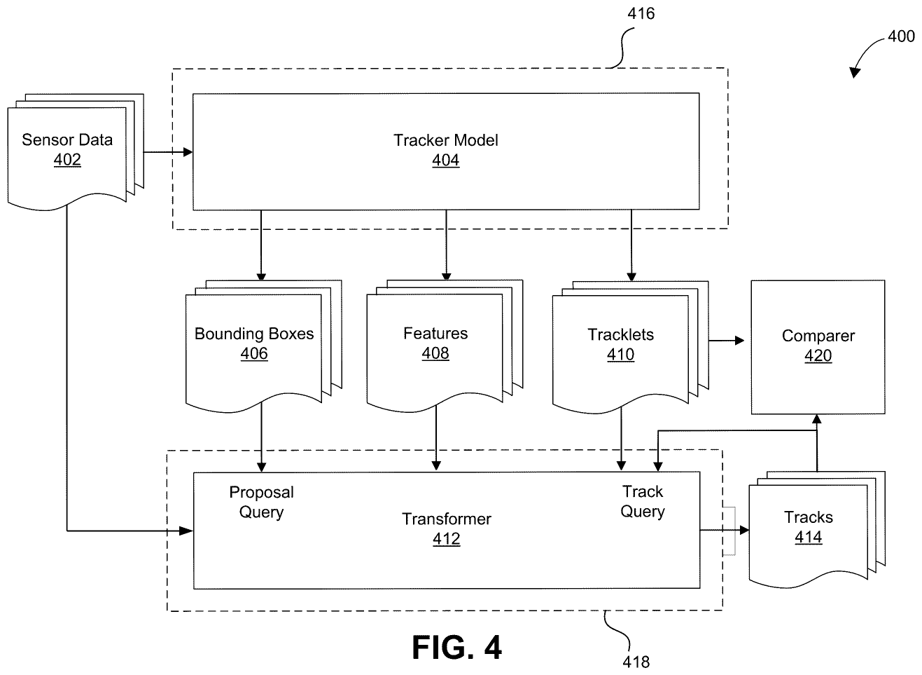

FIG. 4 is a block diagram illustrating a system 400 for tracking objects, according to various aspects of the present disclosure. System 400 may be, or may include, a two-stage tracker including a first stage 416 and a second stage 418. One or both of first stage 416 and second stage 418 may be used at inference to track objects. In some aspects, second stage 418 may be toggled to conserve computational resources. Additionally or alternatively, during training of system 400, first stage 416 and second stage 418 may be used in a two-stage gradient-boosting approach.

Sensor data 402 may be, or may include, a series of frames of image data, a series of frames of radio detection and ranging (RADAR) data, and/or a series of frames of light detection and ranging (LIDAR) data. Furthermore, sensor data 402 may also include full translation and/or rotation (e.g., a translation and/or rotation matrix or matrices) of the observer (EgoMotion) and intrinsic and extrinsic parameters of the sensors. In cases in which sensor data 402 includes image data and RADAR data and/or LIDAR data, the image data and the RADAR data and/or LIDAR data may represent the same scene and may be substantially synchronized. For example, an image frame of the image data may represent the same scene and may be captured at substantially the same time as a corresponding RADAR frame and/or a corresponding LIDAR frame. The same reasoning also is valid for synchronization with observer data (EgoMotion) providing information about the translation and rotation (relative motion).

Tracker model 404 may generate bounding boxes 406, features 408, and tracklets 410 based on sensor data 402. Tracker model 404 may include one or more feature extractors that may generate features 408 based on sensor data 402. Additionally, tracker model 404 may include an object detector that may generate bounding boxes 406 based on features 408. Additionally, tracker model 404 may include a tracker that may generate tracklets 410 based on features 408 and bounding boxes 406. Tracklets 410 may include bounding boxes and identifiers. Tracker model 404 may use EgoMotion data and/or calibration data to account for motion of sensors that captured sensor data 402 when determining tracklets 410.

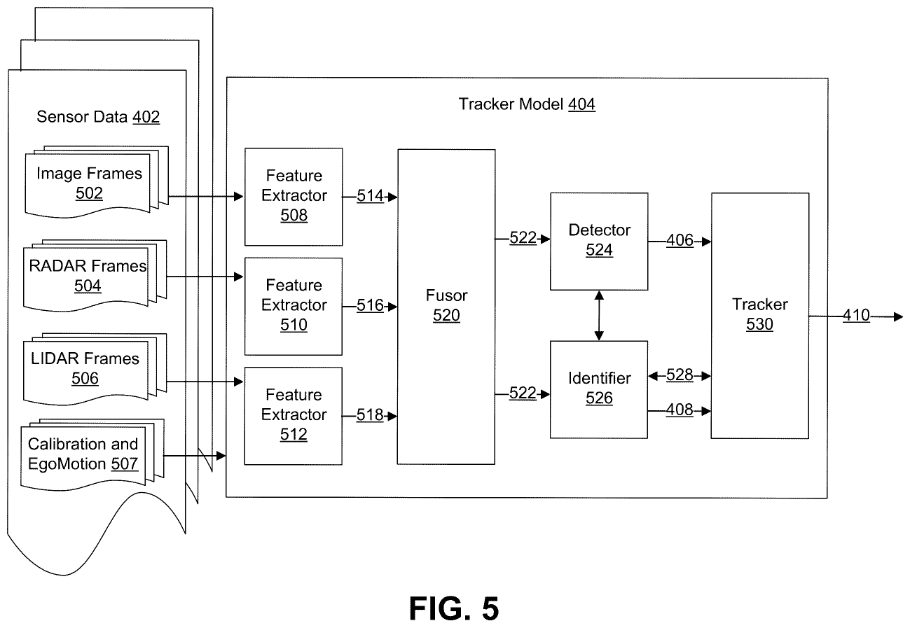

The tracker of tracker model 404 may be, or may include, a filter-based tracker (e.g, including a Kalman filter, an EKF, and/or a UKF). Accordingly, the tracker may exhibit the advantages of a filter-based tracking approach. For example, tracker model 404 may be less computationally expensive (e.g., consume less power and/or processing time) than other tracking approaches (e.g., than transformer-based tracking approaches). Additional detail regarding tracker model 404 is provided with regard to FIG. 5.

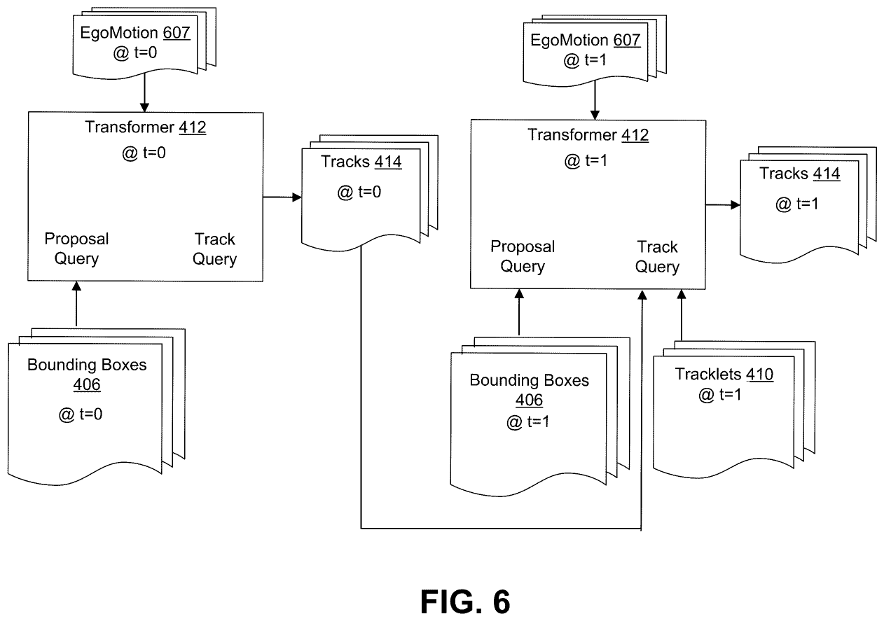

Transformer 412 may generate tracks 414 based on sensor data 402, bounding boxes 406, features 408, tracklets 410, and when available, prior instances of tracks 414. Transformer 412 may use bounding boxes 406 as proposal queries. Proposal queries may be used for detecting newly-detected or missing objects. Additionally, transformer 412 may use tracklets 410 and, when available, prior instances of tracks 414 as track queries. Track query may be used for tracking the position of an object over time. Additional detail regarding transformer 412 using tracks 414 is provided with regard to FIG. 6.

Transformer 412 may implement a transformer-based tracking approach and may exhibit the advantages of a transformer-based tracking approach. For example, transformer 412 may be more accurate and/or provide greater track continuity than other approaches (e.g., than filter-based tracking approaches).

System 400 may determine when to use first stage 416 and second stage 418 to track objects and when to use first stage 416, and not second stage 418, to track objects. For example, system 400 may determine, in some circumstances, to bypass or disable transformer 412 to conserve computing resources. For example, first stage 416 may be sufficient (e.g., produce sufficiently accurate tracks) in many circumstances (e.g., in environments including relatively few objects and/or objects traveling in simple, for example, straight-line paths). Further, first stage 416 may be insufficient (e.g., produce insufficiently accurate tracks) in other circumstances (e.g., in environments including relatively many objects and/or objects traveling in complex paths).

In some aspects, system 400 may use tracker model 404 to generate tracklets 410 while (e.g., any time that) sensor data 402 is being received. Additionally, system 400 may determine when to use transformer 412 to generate tracks 414. Then, system 400 may use transformer 412 to generate tracks 414 at the determined times.

In some aspects, system 400 may determine when to use transformer 412 based on tracking metrics of tracker model 404 and transformer 412. For example, system 400 may continuously use tracker model 404 to generate tracklets 410. Additionally, at intervals, (e.g., for one out of every 10, 20, 50, or 100 frames of sensor data 402), system 400 may use transformer 412 to generate tracks 414. At the intervals, comparer 420 of system 400 may compare tracklets 410 to tracks 414 and system 400 may determine whether to continue using transformer 412 to generate tracks 414 or whether to disable or bypass transformer 412.

For example, comparer 420 may compare an instance of tracklets 410 with a corresponding instance of tracks 414. For example, for a given frame of sensor data 402, tracker model 404 may generate an instance of tracklets 410 and transformer 412 may generate an instance of tracks 414 based on the instance of tracklets 410. Comparer 420 may compare the instance of tracklets 410 with the instance of tracks 414 and generate a similarity score indicative of the similarity between the instance of tracklets 410 and the instance of tracks 414. If the similarity score exceeds a similarity threshold (e.g., indicating that the instance of tracklets 410 is similar to the instance of tracks 414), system 400 may determine to disable or bypass transformer 412. At a later time (e.g., after 10, 20, 50, or 100 frames of sensor data 402 are received), system 400 may determine to reenable transformer 412 to compare a later instance of tracks 414 with a corresponding later instance of tracklets 410.

If the similarity score does not exceed the similarity threshold (e.g., indicating that the instance of tracklets 410 is dissimilar to the instance of tracks 414), system 400 may determine to enable transformer 412. Comparer 420 may continue to compare instances of tracklets 410 with instances of tracks 414. If one or more instances of tracklets 410 are similar to corresponding instances of tracks 414 (e.g., with similarity scores exceeding a threshold), system 400 may determine to disable or bypass transformer 412. At a later time (e.g., after 10, 20, 50, or 100 frames of 402 are received), system 400 may determine to reenable transformer 412 to compare a later instance of tracks 414 with a corresponding later instance of tracklets 410.

In this way (by toggling second stage 418), system 400 may conserve computational resources in circumstances in which first stage 416 is sufficient. Further, system 400 may provide the accuracy of second stage 418 in circumstances in which first stage 416 is insufficient.

Additionally, second stage 418 may be trained to perform well based on training data samples on which first stage 416 does not perform well. For example, second stage 418 may be trained according to a gradient-boosting approach based on training data samples for which first stage 416 produced incorrect results.

For example, tracker model 404 may be trained to produce tracklets 410 through an iterative back-propagation training process. For instance, tracker model 404 may be provided with training sensor data. Tracker model 404 may generate provisional tracklets. The provisional tracklets may be compared with ground-truth tracklets corresponding to the training sensor data. A loss (or error) may be determined based on the difference between the provisional tracklets and the ground-truth tracklets. Parameters of tracker model 404 may be adjusted based on the loss to decrease further differences between further provisional tracklets and ground-truth tracklets based on a gradient-descent training approach.

After tracker model 404 has been trained (e.g., after training tracker model 404 using a pre-determined number of training data samples or after training tracker model 404 to produce results with a certain degree of accuracy), tracker model 404 may be provided with additional training data and data samples for which tracker model 404 produces incorrect results may be identified. For example, after tracker model 404 has been trained using 1,000,000 training data samples, tracker model 404 may be provided with an additional 1,000,000 training data samples. Data samples of the additional training data samples for which tracker model 404 generates incorrect tracks may be identified.

Transformer 412 may be trained using the identified data samples, among other data samples. For example, transformer 412 may be trained to produce tracks 414 through an iterative back-propagation training process. For instance, parameters of tracker model 404 may be frozen. Tracker model 404 may be provided with training sensor data and may generate training bounding boxes, features, and tracklets. Transformer 412 may generate provisional tracks based on the training bounding boxes, features, and tracklets. The provisional tracks may be compared with ground-truth tracks corresponding to the training sensor data. A loss (or error) may be determined based on the difference between the provisional tracks and the ground-truth tracks. Parameters of transformer 412 may be adjusted based on the loss to decrease further differences between further provisional tracks and ground-truth tracks based on a gradient-descent training approach. For the identified data samples (the training data samples for which tracker model 404 generated inaccurate results), weights of the gradient-descent training approach may be adjusted to increase the learning of transformer 412. In this way, transformer 412 may be trained to perform well on training data samples for which tracker model 404 does not perform well.

FIG. 5 is a block diagram illustrating an example implementation of tracker model 404 of FIG. 4, according to various aspects of the present disclosure. Tracker model 404 is illustrated in FIG. 5 including modules, routines, processes, models (e.g., machine-learning models), etc. that collectively perform the operations of tracker model 404 described with regard to FIG. 4.

As mentioned above, sensor data 402 may include image frames 502, RADAR frames 504 and/or LIDAR frames 506. Additionally, sensor data 402 may include calibration data and EgoMotion data 507. The calibration data may be, or may include, data regarding a calibration of various sensors that capture sensor data 402 (e.g., intrinsics). The EgoMotion data may be, or may include, data indicative of a position of sensors that capture sensor data 402. Tracker model 404 may include a feature extractor for each of image frames 502, RADAR frames 504, and/or LIDAR frames 506. For example, tracker model 404 may include an image feature extractor 508 to generate image features 514 based on image frames 502. Additionally, tracker model 404 may include a RADAR feature extractor 510 configured to generate RADAR features 516 based on RADAR frames 504. Additionally or alternatively, tracker model 404 may include a LIDAR feature extractor 512 to generate LIDAR features 518 based on LIDAR frames 506.

Image feature extractor 508, RADAR feature extractor 510, and LIDAR feature extractor 512 may be machine-learning models trained to generate features (e.g., image features 514, RADAR features 516, and LIDAR features 518 respectively) based on sensor data 402 (e.g., based on image frames 502, RADAR frames 504, and LIDAR frames 506 respectively). The features (e.g., image features 514, RADAR features 516, and LIDAR features 518 respectively) may be, or may include, implicit representations of sensor data 402 (e.g., based on image frames 502, RADAR frames 504, and LIDAR frames 506 respectively).

Fusor 520 may fuse image features 514, RADAR features 516, and/or LIDAR features 518 to generate fused features 522. Fused features 522 may be, or may include, an implicit representation of image features 514, RADAR features 516, and/or LIDAR features 518.

Detector 524 may detect objects based on fused features 522. Detector 524 may generate bounding boxes 406 based on the detected objects. Bounding boxes 406 may be indicative of pixel locations in image frames 502 that represent the detected objects, or a bounding box in the world relative to the observer.

Identifier 526 may generate identifiers (IDs 528) for detected objects. In some aspects, identifier 526 may generate IDs 528 for newly-detected objects. For example, identifier 526 may communicate with tracker 530 to generate IDs 528 for objects that are tracked, for example, as part of tracklets 410.

Tracker 530 may generate tracklets 410 based on bounding boxes 406, features 408, and IDs 528. As mentioned above, tracklets 410 may be, or may include, bounding boxes (tracked over image frames 502) and identifiers.

Tracker 530 may implement a filter-based tracking technique to track detected objects across image frames 502. For example, tracker 530 may implement a Kalman filter, an EKF, a UKF, a Bayesian filter, or a similar filter. For instance, tracker 530 may predict states based on an array of tracks, update states, and manage tracks based on the updated states. Tracker 530 may associate measurements based on predicted states and update the state based on the associated measurements.

FIG. 6 is a block diagram illustrating a process for tracking objects, according to various aspects of the present disclosure. FIG. 6 includes two representations of transformer 412 of FIG. 4. Each of the representations of transformer 412 may generate tracks 414 based on bounding boxes 406 and EgoMotion 607. For example, FIG. 6 includes a first representation of transformer 412 at a first time (e.g., @ t=0). Additionally, FIG. 6 includes a second representation of first stage 416 at a second time (e.g., @ t=1). Transformer 412 may use EgoMotion 607 to account for motion of sensors that captured sensor data 402 when transformer 412 determines tracks 414.

The first time may be representative of a first time that transformer 412 is activated or provided with bounding boxes 406 to determine tracks 414. The first time may be representative of a time before which transformer 412 was inactive or bypassed. For example, prior to the first time, tracker model 404 of system 400 may be active and may generate tracklets 410 while transformer 412 is inactive or bypassed. The second time may be representative of a time when an instance of tracks 414 from a prior time is available and relevant. The first time may be based on the receipt of a frame of sensor data 402. The second time may be based on the receipt of a subsequent frame of sensor data 402.

For example, prior to the first time (t=0), system 400 may operate using tracker model 404 and bypassing transformer 412. After an interval, for example, after processing 9 instances of sensor data 402, system 400 may activate transformer 412, for example, to determine a similarity score to determine whether to activate transformer 412, for example, based on a Tracker-Model performance measure or similarity score. At the first time (t=0), system 400 may provide bounding boxes 406 (@ t=0) to transformer 412 and transformer 412 may generate tracks 414 (@ t=0) based on bounding boxes 406 (@ t=0).

According to the example of FIG. 6, system 400 may determine (e.g., based on a similarity between an instance of tracklets 410 generated by tracker model 404 based on sensor data 402 received at the first time and tracks 414 (@ t=0, which are generated based on the instance of bounding boxes 406 (@ t=0)), to enable transformer 412. After enabling transformer 412, a second instance of sensor data 402 may be received and tracker model 404 may generate a second instance of bounding boxes 406 (e.g., bounding boxes 406 @ t=1) and provide the second instance of bounding boxes 406 (@ t=1) to transformer 412 (@ t=1). Transformer 412 (@ t=1) use the second instance of bounding boxes 406 (@ t=1) as proposal queries to generate a second instance of tracks 414 (e.g., tracks 414 @ t=1). Additionally, tracker model 404 may receive sensor data 402 and generate a second instance of tracklets 410 (@ t=1) based on the received sensor data 402. Transformer 412 (@ t=1) use the second instance of tracklets 410 (@ t=1) as a track query to generate tracks 414 (@t=1). Additionally, transformer 412 (@t=1) may use the first instance of tracks 414 (@t=0) as a track query to generate tracks 414 (@t=1).

Transformer 412 may combine tracks 414 (@t=0) with tracklets 410 (@t=1) and use the combined result as the track query. For example, transformer 412 may concatenate tracks 414 (@t=0) with tracklets 410 (@t=1) and use the concatenated tracks 414 (@t=0) and tracklets 410 (@t=1) as the track query.

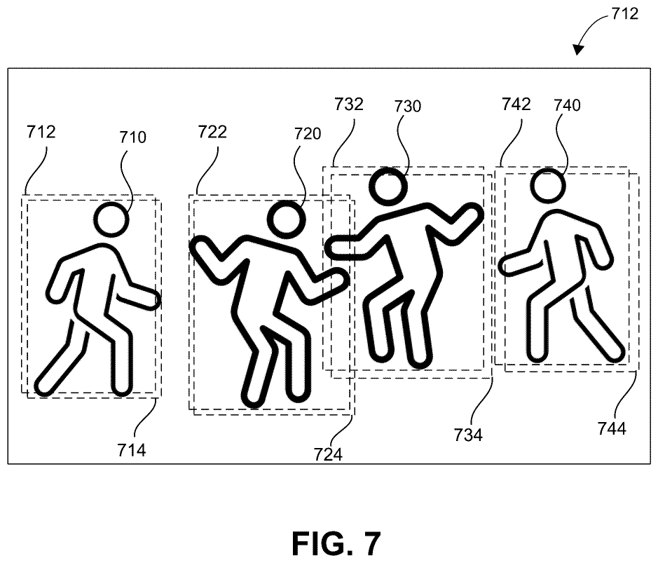

FIG. 7 includes an example image of four people (e.g., for person 710, 720, 730 and 740) overlaid with respective proposal-query predictions and track-query predictions, according to various aspects of the present disclosure. Proposal queries (e.g., proposal queries 712, 722, 732, and 742) may be used for new and missing objects and track queries (e.g., track queries 714, 724, 734, and 744) may be used for locating the objects are highly overlapped (e.g., for person 710, 720, 730 and 740).

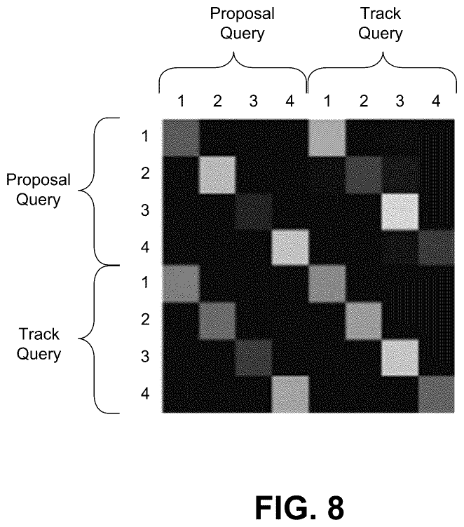

FIG. 8 includes an example query attention map, according to various aspects of the present disclosure. In FIG. 8, light pixels represents high information exchange and dark pixels represent low information exchange. For the same person, the proposal query and corresponding track query shows high information exchange by light pixel. That means with the help of track queries, proposal queries takes care of multiple detections of the same person. With the help of proposal queries, track queries enhances object localization.

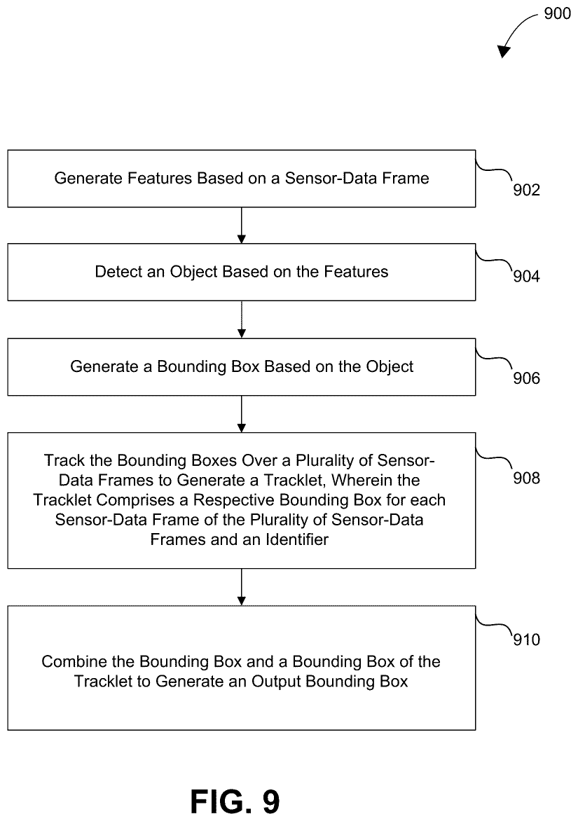

FIG. 9 is a flow diagram illustrating an example process 900 for tracking objects, in accordance with aspects of the present disclosure. One or more operations of process 900 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 900. The one or more operations of process 900 may be implemented as software components that are executed and run on one or more processors.

At block 902, a computing device (or one or more components thereof) may generate features based on a sensor-data frame. For example, image feature extractor 508 may generate image features 514 based on image frames 502. As another example, RADAR feature extractor 510 may generate RADAR features 516 based on RADAR frames 504. As another example, LIDAR feature extractor 512 may generate LIDAR features 518 based on LIDAR frames 506.

In some aspects, the sensor-data frame may be, or may include, an image frame, wherein the at least one processor is configured to generate sensor features based on sensor data; and fuse the sensor features with the features to generate fused features; wherein the object is detected based on the fused features; and wherein the bounding box is generated based on the fused features. For example, image feature extractor 508 may generate image features 514 based on image frames 502 and one or both of RADAR feature extractor 510 may generate RADAR features 516 based on RADAR frames 504 and LIDAR feature extractor 512 may generate LIDAR features 518 based on LIDAR frames 506. Fusor 520 may generate fused features 522 based on image features 514 and one or both of RADAR features 516 and LIDAR features 518. Detector 524 may generate bounding boxes 406 based on fused features 522.

In some aspects, the sensor data may be, or may include, a radio detection and ranging (RADAR) frame and/or a light detection and ranging (LIDAR) frame. For example, sensor data 402 may be, or may include, image frames 502, RADAR frames 504 and/or LIDAR frames 506.

In some aspects, the features may be generated by a feature-extractor machine-learning model. For example, image feature extractor 508 may generate image features 514 based on image frames 502. As another example, RADAR feature extractor 510 may generate RADAR features 516 based on RADAR frames 504. As another example, LIDAR feature extractor 512 may generate LIDAR features 518 based on LIDAR frames 506.

At block 904, the computing device (or one or more components thereof) may detect an object based on the features. For example, detector 524 may detect an object based on fused features 522.

At block 906, the computing device (or one or more components thereof) may generate a bounding box based on the object. For example, detector 524 may generate one of bounding boxes 406 based on the object detected at block 904.

In some aspects, the objects are detected and the bounding box is generated by an object-detector machine-learning model. For example, detector 524 may be, or may include, an object-detector machine-learning model that may generate bounding boxes 406 based on fused features 522.

In some aspects, the computing device (or one or more components thereof) may generate the identifier for the object. For example, identifier 526 may generate features 408 for bounding boxes 406.

In some aspects, after generating a bounding box at block 906, the computing device (or one or more components thereof) may obtain EgoMotion data and/or calibration data. For example, Tracker Model 404 may obtain calibration and EgoMotion 507. The computing device (or one or more components thereof) may use the EgoMotion data and/or calibration data to track the computing device (or one or more components thereof) to subtract motion of the computing device (or one or more components thereof) from motion of track objects.

At block 908, the computing device (or one or more components thereof) may track the bounding box over a plurality of sensor-data frames to generate a tracklet, wherein the tracklet comprises a respective bounding box for each sensor-data frame of the plurality of sensor-data frames and an identifier. For example, tracker 530 may track the bounding box generated at block 906 over a plurality of frames of sensor data 402 to generate one of tracklets 410. The one of tracklets 410 may be, or may include, a respective bounding box for each frame of sensor data 402 and an identifier (e.g., one of IDs 528).

In some aspects, the bounding box is tracked using a Kalman filter. For example, tracker 530 may implement a Kalman filter (or any other Bayesian filter) to generate tracklets 410 based on bounding boxes 406.

At block 910, the computing device (or one or more components thereof) combine the bounding box and a bounding box of the tracklet to generate an output bounding box. For instance, transformer 412 may combine the bounding box (determined at block 906) and a bounding box of the tracklet (determined at block 908) to generate an output bounding box. For example, transformer 412 may generate an output bounding box (e.g., of tracks 414) based on the bounding box determined at block 906 and the tracklet determined at block 908.

In some aspects, the computing device (or one or more components thereof) may combine the bounding box and the bounding box of the tracklet according to a non-max suppression technique.

In some aspects, the computing device (or one or more components thereof) may combine the bounding box and the bounding box of the tracklet according to an intersection-over-union approach.

In some aspects, the computing device (or one or more components thereof) may combine the bounding box and the bounding box of the tracklet according to a total-area approach.

In some aspects, to generate the output bounding box based on the bounding box and the tracklet, the computing device (or one or more components thereof) may process the bounding box and the tracklet using a neural network to generate the output bounding box. For example, transformer 412 may process the bounding box determined at block 906 and the tracklet determined at block 908 to generate the bounding box of tracks 414.

In some aspects, to generate the output bounding box based on the bounding box and the tracklet, the computing device (or one or more components thereof) may combine the bounding box and a bounding box of the tracklet. For example, transformer 412 may combine the bounding box determined at block 906 and the tracklet determined at block 908 to generate the bounding box of tracks 414.

In some aspects, to the combine the bounding box and the bounding box of the tracklet, the computing device (or one or more components thereof) may combine the bounding box and the bounding box of the tracklet according to a non-max suppression technique. For example, transformer 412 may combine the bounding box determined at block 906 and the tracklet determined at block 908 according to a non-max suppression technique to generate the bounding box of tracks 414.

In some aspects, the computing device (or one or more components thereof) may implement a two-stage method to generate the output bounding box. For example, system 400 may include a first stage 416 and a second stage 418. System 400 may generate the bounding box of tracks 414 using first stage 416 and first stage 416.

In some aspects, the computing device (or one or more components thereof) may generate, at a transformer machine-learning model, a track using the bounding box as proposal query and the tracklet as track query. For example, transformer 412 may generate tracks 414 using bounding boxes 406 as a proposal query and tracklets 410 as a track query, for example, as illustrated and described with regard to FIG. 6.

In some aspects, the computing device (or one or more components thereof) may combine a prior track with the tracklet to generate a combined track and provide the combined track to the transformer machine-learning model as a track query. For example, transformer 412 may combine a prior instance of tracks 414 with tracklets 410 and use the combined tracks 414 and tracklets 410 as a track query, for example, as illustrated and described with regard to FIG. 6.

In some aspects, the transformer machine-learning model may be trained according to a gradient-boosting technique using losses from training a tracker machine-learning model. For example, transformer 412 may be trained based on a gradient-boosting technique, using losses from the training of tracker model 404.

In some aspects, the tracker machine-learning model tracks the bounding box to generate the tracklet. For example, the tracker model 404 that generated losses for the gradient-boosting training of transformer 412 may be the same tracker model 404 used in system 400.

In some aspects, a tracker machine-learning model tracks the bounding box to generate the tracklet; training-data samples that result in losses above a loss threshold are identified as the tracker machine-learning model is trained; and gradient-descent weights of the training-data samples are increased as the transformer machine-learning model is trained. For example, tracker model 404 may track bounding boxes 406 to generate tracklets 410. When tracker model 404 is being trained, training-data samples that result in losses above a threshold may be identified. When transformer 412 is being trained, gradient-descent weights may be increased for the identified training-data samples. For example, transformer 412 may be trained according to a gradient-descent technique using losses from the training of tracker model 404.

In some aspects, the computing device (or one or more components thereof) may determine a similarity score based on a comparison between the track and the tracklet and determine whether to bypass the transformer machine-learning model based on the similarity score. For example, comparer 420 may compare one of tracklets 410 (e.g., an output of tracker model 404) with one of tracks 414 (e.g., an output of transformer 412) and determine a similarity score based on the comparison. System 400 may determine to bypass or disable transformer 412 based on the similarity score.

In some aspects, the computing device (or one or more components thereof) may determine a similarity score based on a comparison between a prior track and prior tracklet and based on the similarity score exceeding a dissimilarity threshold, generate the track at the transformer machine-learning model. For example, prior to generating the output bounding box at block 910, the computing device (or one or more components thereof) may determine a similarity score based on a comparison between a prior track and a prior tracklet. The computing device (or one or more components thereof) may then enable transformer 412 and determine the track at block 910 based on the determined similarity score exceeding a threshold.

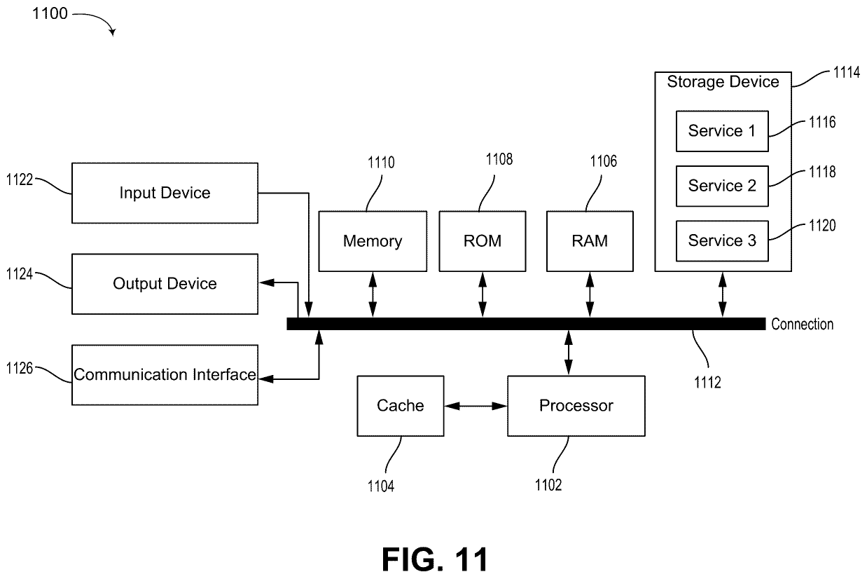

In some examples, as noted previously, the methods described herein (e.g., process 900 of FIG. 9, and/or other methods described herein) can be performed, in whole or in part, by a computing device or apparatus. In one example, one or more of the methods can be performed by, or by another system or device. In another example, one or more of the methods (e.g., process 900, and/or other methods described herein) can be performed, in whole or in part, by the computing-device architecture 1100 shown in FIG. 11. For instance, a computing device with the computing-device architecture 1100 shown in FIG. 11 can include, or be included in, the components of the and can implement the operations of process 900, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 900, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 900, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted above, various aspects of the present disclosure can use machine-learning models or systems.

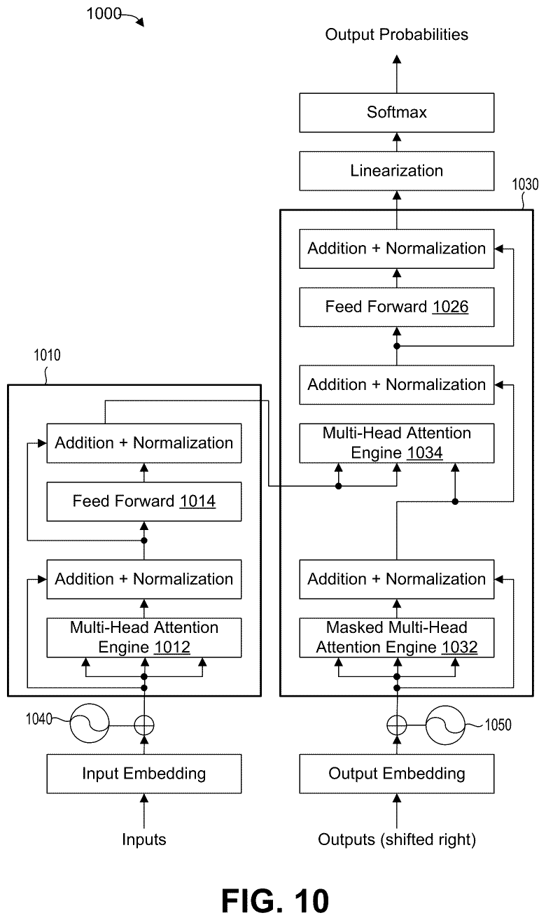

FIG. 10 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 1000 reduces the operations of learning dependencies by using an encoder 1010 and a decoder 1030 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1010 is composed of a stack of six identical layers and each layer has two sub-layers. The first sub-layer is a multi-head self-attention engine 1012, and the second sub-layer is a fully-connected feed-forward network 1014. A residual connection (not shown) connects around each of the sub-layers followed by normalization.

In this example transformer 1000, the decoder 1030 is also composed of a stack of six 6 identical layers. The decoder also includes a masked multi-head self-attention engine 1032, a multi-head attention engine 1034 over the output of the encoder 1010, and a fully-connected feed-forward network 1026. Each layer includes a residual connection (not shown) around the layer, which is followed by layer normalization. The masked multi-head self-attention engine 1032 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1040 to encode positions because the model does not contain recurrence and convolution and relative or absolute position of the tokens is needed. In the transformer 1000, the positional encodings are added to the input embeddings at the bottom layer of the encoder 1010 and the decoder 1030. The positional encodings are summed with the embeddings because the positional encodings and embeddings have the same dimensions. A corresponding position decoder 1050 is configured to decode the positions of the embeddings for the decoder 1030.

In some aspects, the transformer 1000 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1000 can process input sequences of variable length, making it well-suited for natural language processing tasks where input lengths can vary greatly. Additionally, the self-attention mechanism allows the transformer 1000 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 11 illustrates an example computing-device architecture 1100 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1100 may include, implement, or be included in any or all of and/or other devices, modules, or systems described herein. Additionally or alternatively, computing-device architecture 1100 may be configured to perform process 900, and/or other process described herein.

The components of computing-device architecture 1100 are shown in electrical communication with each other using connection 1112, such as a bus. The example computing-device architecture 1100 includes a processing unit (CPU or processor) 1102 and computing device connection 1112 that couples various computing device components including computing device memory 1110, such as read only memory (ROM) 1108 and random-access memory (RAM) 1106, to processor 1102.

Computing-device architecture 1100 can include a cache of high-speed memory connected directly with, in close proximity to, or integrated as part of processor 1102. Computing-device architecture 1100 can copy data from memory 1110 and/or the storage device 1114 to cache 1104 for quick access by processor 1102. In this way, the cache can provide a performance boost that avoids processor 1102 delays while waiting for data. These and other modules can control or be configured to control processor 1102 to perform various actions. Other computing device memory 1110 may be available for use as well. Memory 1110 can include multiple different types of memory with different performance characteristics. Processor 1102 can include any general-purpose processor and a hardware or software service, such as service 1 1116, service 2 1118, and service 3 1120 stored in storage device 1114, configured to control processor 1102 as well as a special-purpose processor where software instructions are incorporated into the processor design. Processor 1102 may be a self-contained system, containing multiple cores or processors, a bus, memory controller, cache, etc. A multi-core processor may be symmetric or asymmetric.

To enable user interaction with the computing-device architecture 1100, input device 1122 can represent any number of input mechanisms, such as a microphone for speech, a touch-sensitive screen for gesture or graphical input, keyboard, mouse, motion input, speech and so forth. Output device 1124 can also be one or more of a number of output mechanisms known to those of skill in the art, such as a display, projector, television, speaker device, etc. In some instances, multimodal computing devices can enable a user to provide multiple types of input to communicate with computing-device architecture 1100. Communication interface 1126 can generally govern and manage the user input and computing device output. There is no restriction on operating on any particular hardware arrangement and therefore the basic features here may easily be substituted for improved hardware or firmware arrangements as they are developed.

Storage device 1114 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1106, read only memory (ROM) 1108, and hybrids thereof. Storage device 1114 can include services 1116, 1118, and 1120 for controlling processor 1102. Other hardware or software modules are contemplated. Storage device 1114 can be connected to the computing device connection 1112. In one aspect, a hardware module that performs a particular function can include the software component stored in a computer-readable medium in connection with the necessary hardware components, such as processor 1102, connection 1112, output device 1124, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“s”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for tracking objects, the apparatus comprising: at least one memory; and at least one processor coupled to the at least one memory and configured to: generate features based on a sensor-data frame; detect an object based on the features; generate a bounding box based on the object; track the bounding box over a plurality of sensor-data frames to generate a tracklet, wherein the tracklet comprises a respective bounding box for each sensor-data frame of the plurality of sensor-data frames and an identifier; and combine the bounding box and a bounding box of the tracklet to generate an output bounding box.
Aspect 2. The apparatus of aspect 1, wherein, to combine the bounding box and the bounding box of the tracklet, the at least one processor is configured to process the bounding box and the tracklet using a neural network to generate the output bounding box.
Aspect 3. The apparatus of any one of aspects 1 or 2, wherein, the at least one processor is configured to combine the bounding box and the bounding box of the tracklet according to a non-max suppression technique.
Aspect 4. The apparatus of any one of aspects 1 to 3, wherein, the at least one processor is configured to combine the bounding box and the bounding box of the tracklet according to an intersection-over-union approach.
Aspect 5. The apparatus of any one of aspects 1 to 4, wherein, the at least one processor is configured to combine the bounding box and the bounding box of the tracklet according to a total-area approach.
Aspect 6. The apparatus of any one of aspects 1 to 5, wherein the at least one processor implements a two-stage method to generate the output bounding box.
Aspect 7. The apparatus of any one of aspects 1 to 6, wherein the at least one processor is configured to, generate, at a transformer machine-learning model, a track using the bounding box as proposal query and the tracklet as track query.
Aspect 8. The apparatus of aspect 7, wherein the at least one processor is configured to: combine a prior track with the tracklet to generate a combined track; and provide the combined track to the transformer machine-learning model as a track query.
Aspect 9. The apparatus of any one of aspects 7 or 8, wherein the transformer machine-learning model is trained according to a gradient-boosting technique using losses from training a tracker machine-learning model.
Aspect 10. The apparatus of aspect 9, wherein the tracker machine-learning model tracks the bounding box to generate the tracklet.
Aspect 11. The apparatus of any one of aspects 7 to 10, wherein: a tracker machine-learning model tracks the bounding box to generate the tracklet; training-data samples that result in losses above a loss threshold are identified as the tracker machine-learning model is trained; and gradient-descent weights of the training-data samples are increased as the transformer machine-learning model is trained.
Aspect 12. The apparatus of any one of aspects 7 to 11, wherein the at least one processor is configured to: determine a similarity score based on a comparison between the track and the tracklet; and determine whether to bypass the transformer machine-learning model based on the similarity score.
Aspect 13. The apparatus of any one of aspects 7 to 12, wherein the at least one processor is configured to: determine a similarity score based on a comparison between a prior track and prior tracklet; and based on the similarity score exceeding a dissimilarity threshold, generate the track at the transformer machine-learning model.
Aspect 14. The apparatus of any one of aspects 1 to 13, wherein the sensor-data frame comprises an image frame, wherein the at least one processor is configured to generate sensor features based on sensor data; and fuse the sensor features with the features to generate fused features; wherein the object is detected based on the fused features; and wherein the bounding box is generated based on the fused features.
Aspect 15. The apparatus of aspect 14, wherein the sensor data comprises at least one of: a radio detection and ranging (RADAR) frame; or a light detection and ranging (LIDAR) frame.
Aspect 16. The apparatus of any one of aspects 1 to 15, wherein the features are generated by a feature-extractor machine-learning model.
Aspect 17. The apparatus of any one of aspects 1 to 16, wherein the objects are detected and the bounding box is generated by an object-detector machine-learning model.
Aspect 18. The apparatus of any one of aspects 1 to 17, wherein the at least one processor is configured to generate the identifier for the object.
Aspect 19. The apparatus of any one of aspects 1 to 18, wherein the bounding box is tracked using a Kalman filter or a Bayesian-filtering approach.
Aspect 20. A method for tracking objects, the method comprising: generating features based on a sensor-data frame; detecting an object based on the features; generating a bounding box based on the object; tracking the bounding box over a plurality of sensor-data frames to generate a tracklet, wherein the tracklet comprises a respective bounding box for each sensor-data frame of the plurality of sensor-data frames and an identifier; and combining the bounding box and a bounding box of the tracklet to generate an output bounding box.
Aspect 21. The method of aspect 20, wherein combining the bounding box and the bounding box of the tracklet comprises processing the bounding box and the tracklet using a neural network to generate the output bounding box.
Aspect 22. The method of any one of aspects 20 or 21, wherein the bounding box and the bounding box of the tracklet are combined according to a non-max suppression technique.
Aspect 23. The method of any one of aspects 20 to 22, wherein the bounding box and the bounding box of the tracklet are combined according to an intersect-over-intersect approach.
Aspect 24. The method of any one of aspects 20 to 23, wherein the bounding box and the bounding box of the tracklet are combined according to a total-area approach.
Aspect 25. The method of any one of aspects 20 to 24, wherein the method comprises a two-stage method.
Aspect 26. The method of any one of aspects 20 to 25, further comprising generating, at a transformer machine-learning model, a track using the bounding box as proposal query and the tracklet as track query.
Aspect 27. The method of aspect 26, further comprising: combining a prior track with the tracklet to generate a combined track; and providing the combined track to the transformer machine-learning model as a track query.
Aspect 28. The method of any one of aspects 26 or 27, wherein the transformer machine-learning model is trained according to a gradient-boosting technique using losses from training a tracker machine-learning model.
Aspect 29. The method of aspect 28, wherein the tracker machine-learning model tracks the bounding box to generate the tracklet.
Aspect 30. The method of any one of aspects 26 to 29, wherein: a tracker machine-learning model tracks the bounding box to generate the tracklet; training-data samples that result in losses above a loss threshold are identified as the tracker machine-learning model is trained; and gradient-descent weights of the training-data samples are increased as the transformer machine-learning model is trained.
Aspect 31. The method of any one of aspects 26 to 30, further comprising: determining a similarity score based on a comparison between the track and the tracklet; and determining whether to bypass the transformer machine-learning model based on the similarity score.
Aspect 32. The method of any one of aspects 26 to 31, further comprising: determining a similarity score based on a comparison between a prior track and prior tracklet; and based on the similarity score exceeding a dissimilarity threshold, generating the track at the transformer machine-learning model.
Aspect 33. The method of any one of aspects 20 to 32, wherein the sensor-data frame comprises an image frame, the method further comprising generating sensor features based on sensor data; and fusing the sensor features with the features to generate fused features; wherein the object is detected based on the fused features; and wherein the bounding box is generated based on the fused features.
Aspect 34. The method of aspect 33, wherein the sensor data comprises at least one of: a radio detection and ranging (RADAR) frame; or a light detection and ranging (LIDAR) frame.
Aspect 35. The method of any one of aspects 20 to 34, wherein the features are generated by a feature-extractor machine-learning model.
Aspect 36. The method of any one of aspects 20 to 35, wherein the objects are detected and the bounding box is generated by an object-detector machine-learning model.
Aspect 37. The method of any one of aspects 20 to 36, further comprising generating the identifier for the object.
Aspect 38. The method of any one of aspects 20 to 37, wherein the bounding box is tracked using a Kalman filter or a Bayesian-filtering approach.
Aspect 39. A non-transitory computer-readable storage medium having stored thereon instructions that, when executed by at least one processor, cause the at least one processor to perform operations according to any of aspects 20 to 38.
Aspect 40. An apparatus for providing virtual content for display, the apparatus comprising one or more means for perform operations according to any of aspects 20 to 38.

What is claimed is:

1. An apparatus for tracking objects, the apparatus comprising:
at least one memory; and
at least one processor coupled to the at least one memory and configured to:
generate features based on a sensor-data frame;
detect an object based on the features;
generate a bounding box based on the object;
track the bounding box over a plurality of sensor-data frames to generate a tracklet, wherein the tracklet comprises a respective bounding box for each sensor-data frame of the plurality of sensor-data frames and an identifier; and
combine the bounding box and a bounding box of the tracklet to generate an output bounding box.

2. The apparatus of claim 1, wherein, to combine the bounding box and the bounding box of the tracklet, the at least one processor is configured to process the bounding box and the tracklet using a neural network to generate the output bounding box.

3. The apparatus of claim 1, wherein, the at least one processor is configured to combine the bounding box and the bounding box of the tracklet according to a non-max suppression technique.

4. The apparatus of claim 1, wherein, the at least one processor is configured to combine the bounding box and the bounding box of the tracklet according to an intersection-over-union approach.

5. The apparatus of claim 1, wherein, the at least one processor is configured to combine the bounding box and the bounding box of the tracklet according to a total-area approach.

6. The apparatus of claim 1, wherein the at least one processor implements a two-stage method to generate the output bounding box.

7. The apparatus of claim 1, wherein the at least one processor is configured to, generate, at a transformer machine-learning model, a track using the bounding box as proposal query and the tracklet as track query.

8. The apparatus of claim 7, wherein the at least one processor is configured to:
combine a prior track with the tracklet to generate a combined track; and
provide the combined track to the transformer machine-learning model as a track query.

9. The apparatus of claim 7, wherein the transformer machine-learning model is trained according to a gradient-boosting technique using losses from training a tracker machine-learning model.

10. The apparatus of claim 9, wherein the tracker machine-learning model tracks the bounding box to generate the tracklet.

11. The apparatus of claim 7, wherein:
a tracker machine-learning model tracks the bounding box to generate the tracklet;
training-data samples that result in losses above a loss threshold are identified as the tracker machine-learning model is trained; and
gradient-descent weights of the training-data samples are increased as the transformer machine-learning model is trained.

12. The apparatus of claim 7, wherein the at least one processor is configured to:
determine a similarity score based on a comparison between the track and the tracklet; and
determine whether to bypass the transformer machine-learning model based on the similarity score.

13. The apparatus of claim 7, wherein the at least one processor is configured to:
determine a similarity score based on a comparison between a prior track and prior tracklet; and
based on the similarity score exceeding a dissimilarity threshold, generate the track at the transformer machine-learning model.

14. The apparatus of claim 1, wherein the sensor-data frame comprises an image frame, wherein the at least one processor is configured to generate sensor features based on sensor data;
and fuse the sensor features with the features to generate fused features; wherein the object is detected based on the fused features; and wherein the bounding box is generated based on the fused features.

15. The apparatus of claim 14, wherein the sensor data comprises at least one of:
a radio detection and ranging (RADAR) frame; or
a light detection and ranging (LIDAR) frame.

16. The apparatus of claim 1, wherein the features are generated by a feature-extractor machine-learning model.

17. The apparatus of claim 1, wherein the objects are detected and the bounding box is generated by an object-detector machine-learning model.

18. The apparatus of claim 1, wherein the at least one processor is configured to generate the identifier for the object.

19. The apparatus of claim 1, wherein the bounding box is tracked using a Kalman filter or a Bayesian-filtering approach.

20. A method for tracking objects, the method comprising:
generating features based on a sensor-data frame;
detecting an object based on the features;
generating a bounding box based on the object;
tracking the bounding box over a plurality of sensor-data frames to generate a tracklet, wherein the tracklet comprises a respective bounding box for each sensor-data frame of the plurality of sensor-data frames and an identifier; and
combining the bounding box and a bounding box of the tracklet to generate an output bounding box.
